(19) United States
(12) Patent Application Publication
(10) Pub. No.: US 2025/0337178 A1
(43) Pub. Date: Oct. 30, 2025

(54) TERMINAL FITTING

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Akihiro NISHITANI, Mie (JP)

(21) Appl. No.: 18/871,485

(22) PCT Filed: May 19, 2023
(86) PCT No.: PCT/JP2023/018686

§ 371 Date: Dec. 4, 2024

(30) Foreign Application Priority Data
Jun. 9, 2022 (JP) 2022-093852

(51) Int. Cl. H01R 12/69

(52) U.S. Cl. CPC H01R 12/69

(57) ABSTRACT

A terminal fitting (10) includes a detached-side terminal portion (12) to be connected to a mating terminal (T), a mounting-side terminal portion (11) to be mounted on a circuit board (P) and a stress absorbing portion (18) arranged between the detached-side terminal portion (12) and the mounting-side terminal portion (11). Stress generated in the detached-side terminal portion (12) and the mounting-side terminal portion (11), out of the terminal fitting (10), can be relaxed by the resilient deformation of the stress absorbing portion (18).

### TECHNICAL FIELD

The present disclosure relates to a terminal fitting used in a connector.

### BACKGROUND

Patent Document 1 discloses a terminal fitting provided with a terminal portion to be connected to a mating terminal, a terminal portion to be mounted on a circuit body and a linking portion linking the both terminal portions, the terminal portions and the linking portion being linearly arranged, as a terminal fitting used in a connector used for a printed board.

### PRIOR ART DOCUMENT

### Patent Document

Patent Document 1: JP 2020-021595 A

### SUMMARY OF THE INVENTION

### Problems to be Solved

Stress is generated when the terminal fitting expands or contracts due to an ambient temperature variation. The terminal fitting may be broken or experience a connection failure by the stress.

The present disclosure was completed on the basis of the above situation and aims to relax stress generated in a terminal fitting.

### Means to Solve the Problem

The present disclosure is directed to a terminal fitting with a detached-side terminal portion to be connected to a mating terminal, a mounting-side terminal portion to be mounted on a circuit board, and a stress absorbing portion arranged between the detached-side terminal portion and the mounting-side terminal portion.

### Effect of the Invention

According to the present disclosure, stress generated in a terminal fitting can be relaxed.

### BRIEF DESCRIPTION OF THE DRAWINGS

FIG. 1 is a perspective view of a connector unit of one embodiment.

FIG. 2 is a section of the connector unit.

FIG. 3 is an exploded perspective view of the connector unit.

FIG. 4 is a perspective view of a terminal fitting.

FIG. 5 is a side view of the terminal fitting.

FIG. 6 is a plan view in section of the terminal fitting.

FIG. 7 is a front view of the terminal fitting.

FIG. 8 is a section along X-X of FIG. 6.

### DETAILED DESCRIPTION TO EXECUTE THE INVENTION

### Description of Embodiments of Present Disclosure

First, embodiments of the present disclosure are listed and described.

(1) The terminal fitting of the present disclosure is provided with a detached-side terminal portion to be connected to a mating terminal, a mounting-side terminal portion to be mounted on a circuit board, and a stress absorbing portion arranged between the detached-side terminal portion and the mounting-side terminal portion. According to this configuration, stress generated in the detached-side terminal portion and the mounting-side terminal portion, out of the terminal fitting, can be relaxed by the resilient deformation of the stress absorbing portion.

(2) Preferably, the stress absorbing portion and the detached-side terminal portion are connected at an obtuse angle, and the stress absorbing portion and the mounting-side terminal portion are connected at an obtuse angle. According to this configuration, the material cost of the terminal fitting can be reduced as compared to the case where parts of the stress absorbing portion connected to the detached-side terminal portion and the mounting-side terminal portion are right-angled or acute-angled. Further, since stress hardly concentrates on the bent parts in both front and rear end parts of the stress absorbing portion, breakage hardly occurs.

(3) Preferably, the detached-side terminal portion includes a flat plate portion directly connected to the stress absorbing portion, and a reinforcing portion for reinforcing the flat plate portion. According to this configuration, since the rigidity of the flat plate portion can be enhanced, stress generated in the flat plate portion can be reduced.

(4) Preferably, the reinforcing portion includes a first reinforcement plate portion folded from one side edge part, out of two side edge parts along a length direction of the flat plate portion, and arranged side by side with the flat plate portion in a plate thickness direction. According to this configuration, the first reinforcement plate portion is folded from the side edge part along the length direction of the flat plate portion and arranged side by side with the flat plate portion in the plate thickness direction, the rigidity of the flat plate portion is enhanced.

(5) Preferably, the reinforcing portion includes a second reinforcement plate portion extending in the plate thickness direction from the other side edge part, out of the two side edge parts along the length direction of the flat plate portion. According to this configuration, since the second reinforcement plate portion extends perpendicularly from the flat plate portion, the rigidity of the flat plate portion is enhanced.

(6) Preferably, a long reinforcement plate portion is provided which includes the first reinforcement plate portion and is arranged along the flat plate portion, the stress absorbing portion and the mounting-side terminal portion, and a side edge part along the length direction of the long reinforcement plate portion is connected to a side edge part along the length direction of the flat plate portion and a side edge part along the length direction of the mounting-side terminal portion and separated from a side edge part along the length direction of the stress absorbing portion. According to this configuration, since the long reinforcement plate portion is connected to the side edge parts along the length direction of the flat plate portion and the mounting-side terminal portion, the rigidity of the entire terminal fitting can be enhanced. Since the stress absorbing portion is not directly connected to the long reinforcement plate portion, a stress relaxation function is not impaired.

(7) Preferably, a tip-side reinforcement plate portion arranged along the mounting-side terminal portion, out of the long reinforcement plate portion, is formed with a step portion for contacting an opening edge part of a through hole in the circuit board. According to this configuration, an insertion depth of the mounting-side terminal portion into the circuit board is constant and stress is uniformly applied to each terminal fitting, wherefore stress is hardly locally generated in each terminal fitting.

(8) Preferably, the detached-side terminal portion includes a penetrating tube portion, a spring piece for resiliently contacting the mating terminal is provided in the tube portion, and the mounting-side terminal portion is arranged outside the tube portion when the detached-side terminal portion and the mounting-side terminal portion are viewed in a penetration direction of the tube portion. According to this configuration, when a clearance (gap) between a wall surface inside the tube portion and the spring piece is inspected in a gap inspection, the mounting-side terminal portion is not present on a propagation path of inspection light such as laser light. Thus, the gap inspection can be properly conducted.

### DETAILS OF EMBODIMENT OF PRESENT DISCLOSURE

### Embodiment

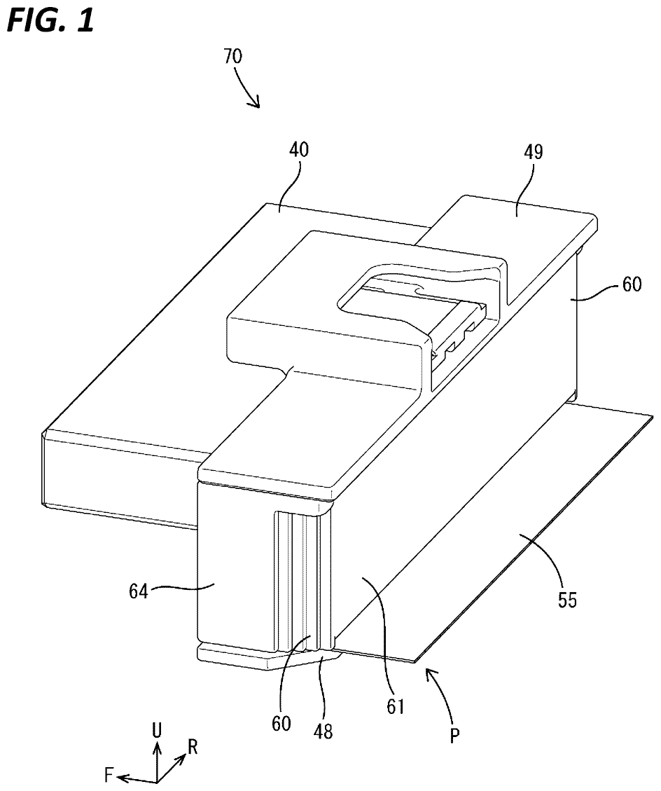

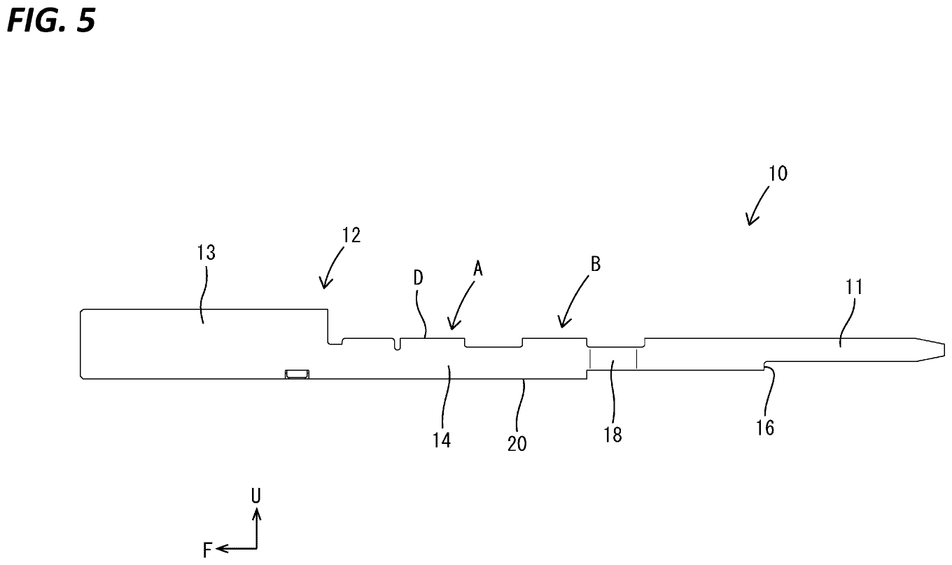

One specific embodiment of the present disclosure is described below with reference to FIGS. 1 to 8. The present disclosure is not limited to these illustrations, but is represented by claims and includes all changes in the scope of claims and in the meaning and scope of equivalents. In FIGS. 1 to 8, a “front side”, an “upper side” and a “right side” are represented by “F”, “U” and “R”.

### [Configuration of Connector Unit 70]

As shown in FIGS. 1 to 3, a connector unit 70 of this embodiment is provided with an outer housing 40, an inner housing 25, a plurality of terminal fittings 10, a circuit board P and a holder 60.

### [Configuration of Circuit Board P]

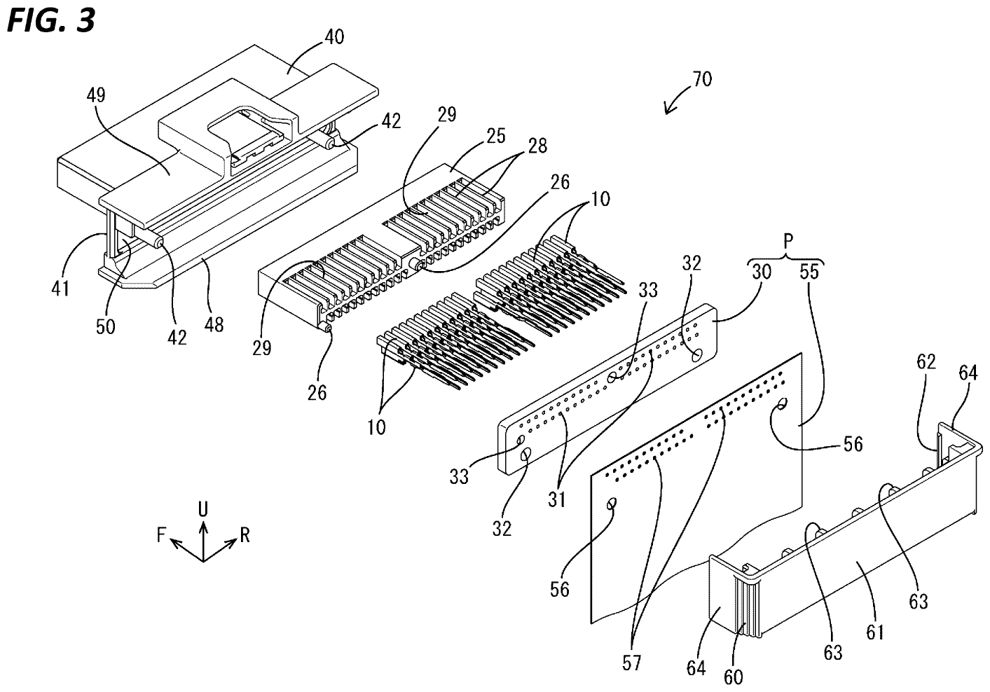

As shown in FIGS. 1 and 3, the circuit board P is provided with an FPC 55 and a support plate 30. As shown in FIGS. 1 to 3, the FPC 55 is an abbreviation of flexible printed circuits, has a thin sheet shape and has flexibility. As shown in FIG. 3, the FPC 55 is formed with a plurality of connection holes 57, through which mounting-side terminal portions 11 of the terminal fittings 10 are individually passed. The FPC 55 is structured by sandwiching a thin film-like conductor layer constituting a predetermined wiring pattern by insulating films. Due to this structure, the FPC 55 can be flexibly deformed by being curved while maintaining electrical properties. The FPC 55 is formed with a pair of first positioning holes 56.

As shown in FIGS. 1 to 3, the support plate 30 reinforces the FPC 55 by being bonded to the FPC 55. The support plate 30 is formed with a plurality of guide holes 31 to be aligned with the connection holes 57. The support plate 30 is formed with a pair of second positioning holes 32 to be aligned with the first positioning holes 56 and two third positioning holes 33 to be closed by the FPC 55. To absorb positional deviations of the guide holes 31 and the connection holes 57 when the support plate 30 is bonded to the FPC 55, the guide holes 31 have a larger opening than the connection holes 57.

### [Configuration of Inner Housing 25]

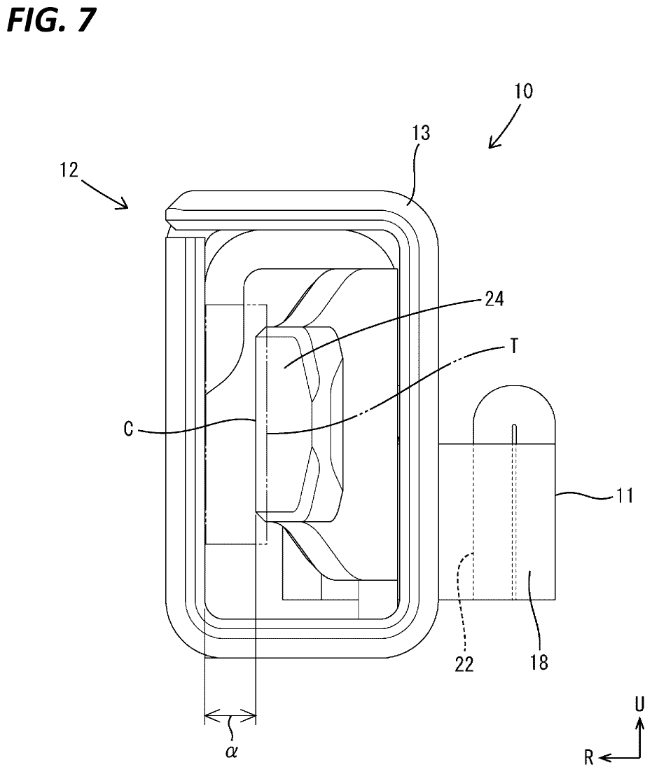

The inner housing 25 is made of synthetic resin and has a flat rectangular parallelepiped shape as shown in FIGS. 1 to 3. The inner housing 25 is formed with a plurality of elongated terminal accommodation chambers 29 partitioned by terminal accommodation walls 28 to individually accommodate the plurality of terminal fittings 10. A terminal through hole 27 is formed in a front end part of the terminal accommodation chamber 29, and a mating terminal T (see FIG. 7) is insertable into the terminal accommodation chamber 29 through the terminal through hole 27. The inner housing 25 includes two inner engaging projections 26. The inner housing 25 is fixed to the support plate 30 with the inner engaging projections 26 fit in the third positioning holes 33. By fitting the inner engaging projections 26 into the third positioning holes 33, the mounting-side terminal portions 11 of the terminal fittings 10 accommodated in the inner housing 25 are inserted into the guide holes 31 and the connection holes 57 without positional deviations.

### [Configuration of Outer Housing 40]

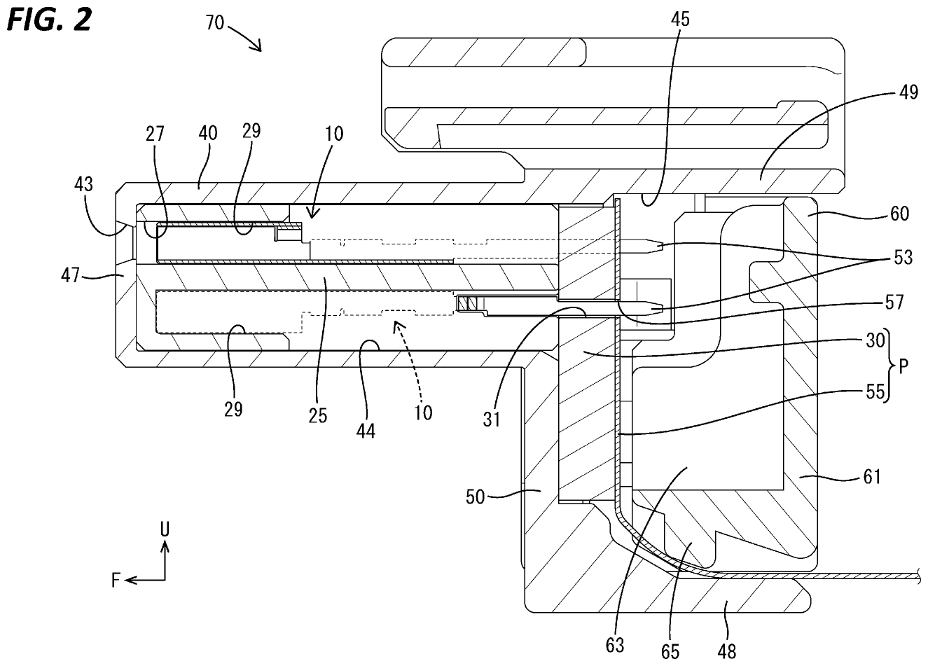

As shown in FIG. 2, the outer housing 40 includes a housing accommodation chamber 44 for accommodating the inner housing 25. A front end part of the housing accommodation chamber 44 is formed with a front wall portion 47 and terminal insertion openings 43 penetrating through the front wall portion 47 and aligned with the terminal through holes 27. As shown in FIGS. 2 and 3, the outer housing 40 includes an inner bottom 50 extending perpendicularly from the rear end opening edge of the housing accommodation chamber 44 and a lower wall portion 48 and an upper wall portion 49 extending rearward from both upper and lower edge parts of the inner bottom 50. A pair of cylindrical outer engaging projections 42 are formed on both left and right end parts of the inner bottom 50. The outer housing 40 is mounted on the circuit board P (support plate 30 and FPC 55) with the outer engaging projections 42 fit in the second positioning holes 32 and the first positioning holes 56.

### [Configuration of Holder 60]

As shown in FIGS. 1 to 3, the holder 60 includes a base plate portion 61 having a central part substantially in the shape of a rectangular parallelepiped plate and both left and right end parts curved inward. A pair of protruding portions 64 project from the both left and right end parts of the base plate portion 61. The holder 60 includes outer engaging claws 62 extending inward from edge parts of the protruding portions 64. The holder 60 is assembled with the outer housing 40 by locking the outer engaging claws 62 to inner engaging claws 41 of the outer housing 40.

With the outer housing 40 and the holder 60 assembled, a protection space 45 surrounded by the inner bottom 50, the lower wall portion 58, the upper wall portion 49 and the base plate portion 61 is formed as shown in FIG. 2. The support plate 30, a part of the FPC 55 and the mounting-side terminal portions 11 of the terminal fittings 10 passed through the connection holes 57 are accommodated in the protection space 45. A plurality of suppressing plates 63 in the form of flat plates projecting forward from the base plate portion 61 are formed side by side in parallel in a lateral direction. Lower end parts of the plurality of suppressing plates 63 are connected via a coupling portion 65 in the lateral direction. A slit-like clearance 51 allowing communication between the protection space 45 and a space behind and outside the holder 60 is formed between the coupling portion 65 and the lower wall portion 48.

### [Configuration of Terminal Fitting 10]

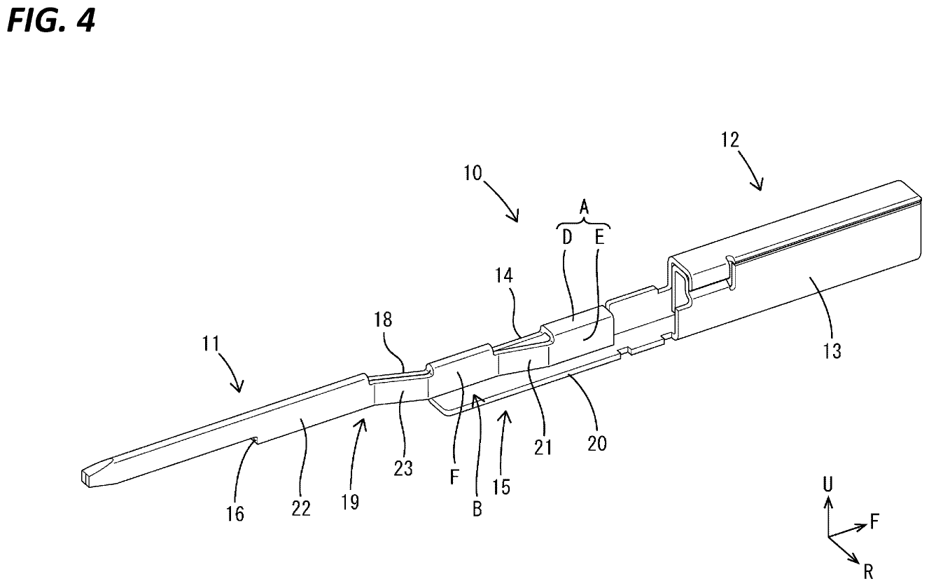

As shown in FIGS. 4 to 8, the terminal fitting 10 is a single component in which a detached-side terminal portion 12, a stress absorbing portion 18 and the mounting-side terminal portion 11 are integrally formed, and has a shape elongated in a front-rear direction as a whole. The detached-side terminal portion 12 is arranged in a front end part of the terminal fitting 10 and includes a tube portion 13 having a rectangular tube shape and a flat plate portion 14. The detached-side terminal portion 12 is accommodated into the terminal accommodation chamber 29 of the inner housing 25 to be connectable to the mating terminal.

The tube portion 13 penetrates in the front-rear direction. A spring piece 24 is arranged inside the tube portion 13. The spring piece 24 is constituted by a plate portion extending in the front-rear direction and bent. In a side view of the terminal fitting 10, the spring piece 24 is bent into a chevron shape. Out of the spring piece 24, a bent portion closest to a right wall portion of the tube portion 13 functions as a contact point portion C for contacting the mating terminal T. As shown in FIG. 7, in a front view of the tube portion 13, a clearance a smaller than a thickness of the mating terminal T is ensured between the contact point portion C and the right wall portion of the tube portion. The mating terminal T is inserted into the tube portion 13 from the front of the terminal fitting 10 and forces itself into the clearance a while resiliently deforming the spring piece 24. In this way, the detached-side terminal portion 12 of the terminal fitting 10 and the mating terminal T are electrically (conductively) connected. The mating terminal T can be pulled out from the tube portion 13.

The flat plate portion 14 is in the form of an elongated flat plate having a plate thickness direction oriented in the front-rear direction. The flat plate portion 14 is flush with and linearly extends forward from the rear end of a left wall portion of the tube portion 13. The detached-side terminal portion 12 includes a reinforcing portion 15 for reinforcing the flat plate portion 14. The reinforcing portion 15 includes a first reinforcement plate portion (reinforcement plate portion A and reinforcement plate portion B) and a second reinforcement plate portion 20. The reinforcement plate portions A and B are connected to an upper end edge part, out of two upper and lower side edge parts along a length direction of the flat plate portion 14. The reinforcement plate portion A includes a reinforcement plate D extending rightward perpendicularly from the upper end edge part of the flat plate portion 14 and a reinforcement plate E extending downward perpendicularly from the reinforcement plate D. The reinforcement plate E is arranged side by side with the flat plate portion 14 while being spaced apart in the lateral direction.

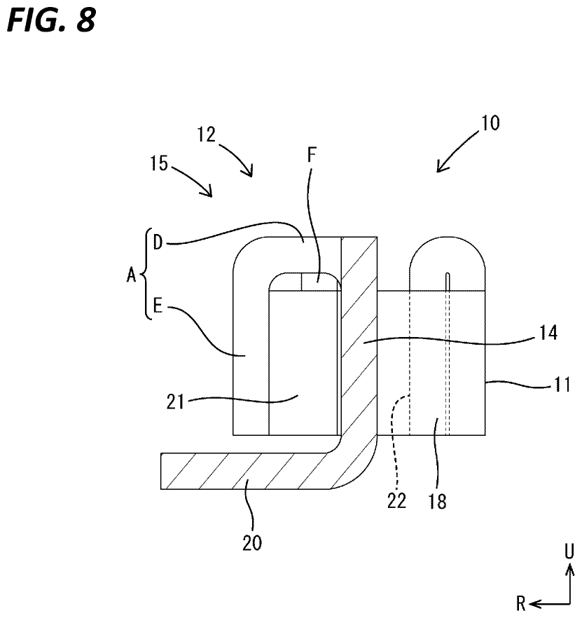

As shown in FIG. 8, in a front view, the flat plate portion 14, the reinforcement plate D and the reinforcement plate E form a substantially vertically inverted U shape. The flat plate portion 14 and the reinforcement plate E are sufficiently spaced apart in the plate thickness direction (lateral direction). Since the reinforcement plate E is arranged apart from the flat plate portion 14, the reinforcement plates D, E are resiliently deformed to be obliquely displaced to a left lower side due to the above clearance, for example, when an external force obliquely acts on the reinforcement plate portion A from a right upper side. By this resilient deformation, stress generated in the flat plate portion 14 can be relaxed.

The reinforcement plate portion B includes a reinforcement plate F folded along the flat plate portion 14 from the upper end edge part of the flat plate portion 14. The flat plate portion 14 and the reinforcement plate F are arranged in close contact with or in proximity to each other. Since a clearance in the plate thickness direction is hardly present between the flat plate portion 14 and the reinforcement plate F, the reinforcement plate F is hardly resiliently deformed when the reinforcement plate portion B receives an external force. However, the doubled flat plate portion 14 and reinforcement plate F have a high rigidity since constituting a laminated structure having a large thickness as a whole.

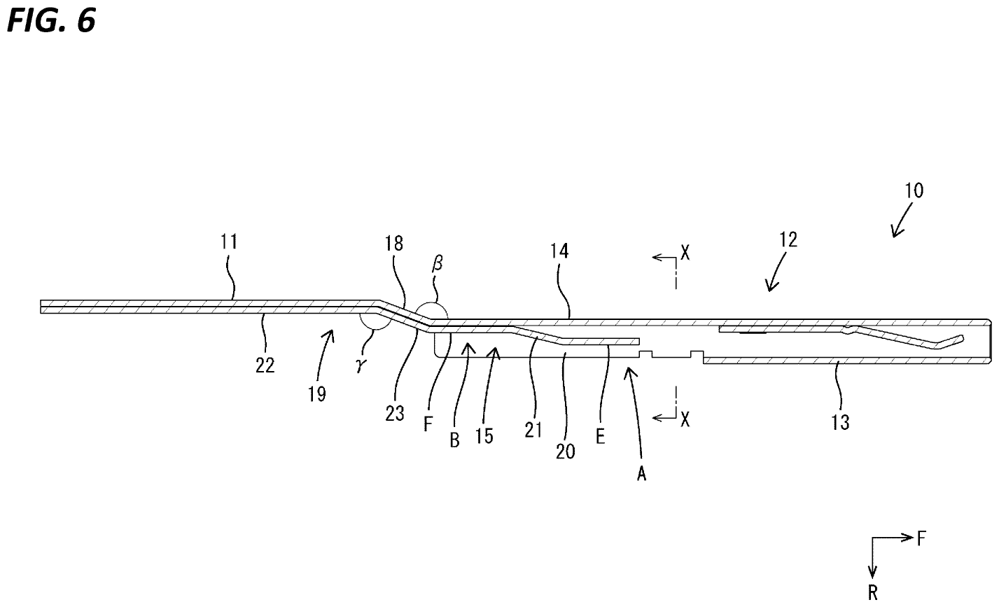

A front end edge part and a rear end edge part of a coupling plate portion 21 are integrally connected to a rear end edge part of the reinforcement plate E and a front end edge part of the reinforcement plate F. As described above, since the clearance in the plate thickness direction between the flat plate portion 14 and the reinforcement plate E and the clearance in the plate thickness direction between the flat plate portion 14 and the reinforcement plate F are different, the coupling plate portion 21 is inclined to the lateral direction in a plan view of the terminal fitting 10 as shown in FIG. 6. The coupling plate portion 21 is not folded in the plate thickness direction from the upper end edge part of the flat plate portion 14. That is, the upper end edge part of the flat plate portion 14 is connected to upper end edge parts of the reinforcement plate portions A, B, but separated from the upper end edge of the coupling plate portion 21.

The detached-side terminal portion 12 includes the second reinforcement plate portion 20 for reinforcing the flat plate portion 14. The second reinforcement plate portion 20 is a part in the form of an elongated flat plate flush with and extending rearward from the rear end of the lower wall portion of the tube portion 13. A left side edge part of the second reinforcement plate portion 20 is connected perpendicularly to the lower end edge part, out of the two upper and lower side edge parts along the length direction of the flat plate portion 14. The second reinforcement plate portion 20 is separated from the lower side surfaces of the reinforcement plates E, F and the coupling plate 21.

Since the second reinforcement plate portion 20 extends perpendicularly from the lower end edge part (side edge part along the length direction) of the flat plate portion 14, the rigidity of the flat plate portion 14 is enhanced by the second reinforcement plate portion 20. By enhancing the rigidity of the flat plate portion 14, the buckling deformation of the flat plate portion 14 is prevented when the mating terminal T and the tube portion 13 are connected. Since the second reinforcement plate portion 20 is perpendicularly facing the reinforcement plates E, F in the vertical direction, even if the reinforcement plate portion A receives a force from above and is deformed downward, the second reinforcement plate portion 20 serves as a support and excessive deformation of the reinforcement plate portion A is suppressed. As just described, the detached-side terminal portion 12 has a high rigidity by the presence of the first reinforcement plate portion (reinforcement plate portions A, B) and the second reinforcement plate portion 20.

The mounting-side terminal portion 11 is in the form of a plate parallel to the flat plate portion 14 and elongated in the front-rear direction. A rear end part of the mounting-side terminal portion 11 has a tapered shape to be insertable into the guide hole 31 of the support plate 30 and the connection hole 57 of the FPC 55. The mounting-side terminal portion 11 has a connection function to the wiring pattern of the FPC 55. The mounting-side terminal portion 11 is inserted into the guide hole 31 of the support plate 30 and the connection hole 57 of the FPC 55 and projects rearward from the FPC 55. A through portion 53 projecting rearward from the FPC 55, out of the mounting-side terminal portion 11, is fixed to the FPC 55 by soldering or the like. Each terminal fitting 10 is arranged to project forward from the FPC 55 and connected to the wiring pattern of the FPC 55.

The terminal fitting 10 includes a tip-side reinforcement plate portion 22. The tip-side reinforcement plate portion 22 is a part folded along the right side surface of the mounting-side terminal portion 11 from an upper end edge part, out of two upper and lower side edge parts along the length direction of the mounting-side terminal portion 11. The mounting-side terminal portion 11 and the tip-side reinforcement plate portion 22 are in close contact and almost no clearance is present in the plate thickness direction. The mounting-side terminal portion 11 and the tip-side reinforcement plate portion 22 are formed with a step portion 16 for contacting an opening edge part 34 of the guide hole 31 of the support plate 30.

The stress absorbing portion 18 is arranged between the mounting-side terminal portion 11 and the detached-side terminal portion 12. As shown in FIG. 6, in a plan view, a front end part of the stress absorbing portion 18 is connected to a rear end part of the detached-side terminal portion 12 at an obtuse angle β. In the plan view, a rear end part of the stress absorbing portion 18 is connected to a front end part of the mounting-side terminal portion 11 at an obtuse angle γ. The obtuse angles β, γ are equal. Since acute-angled bent portions are not formed in the both front and rear end parts of the stress absorbing portion 18, even if an external force is applied to the terminal fitting 10 in the lateral direction and the front-rear direction, stress hardly concentrates on the both front and rear end parts of the stress absorbing portion 18. The terminal fitting 10 includes a coupling/reinforcing portion 23 arranged side by side with the stress absorbing portion 18 in the plate thickness direction. A front end part of the coupling/reinforcing portion 23 is connected to a rear end part of the reinforcement plate F at the obtuse angle R. A rear end part of the coupling/reinforcing portion 23 is connected to a front end part of the tip-side reinforcement plate portion 22 at the obtuse angle γ.

The terminal fitting 10 includes a long reinforcement plate portion 19 constituted by the reinforcement plate F, the coupling plate 21, the reinforcement plate E, the coupling/reinforcing portion 23 and the tip-side reinforcement plate portion 22. The long reinforcement plate portion 19 is a reinforcing part elongated in the front-rear direction and arranged along the flat plate portion 14, the stress absorbing portion 18 and the mounting-side terminal portion 11. An upper end edge part of the long reinforcement plate portion 19 is connected to a part of the upper end edge part of the flat plate portion 14 over the entire upper end edge part of the mounting-side terminal portion 11, but not connected to the entire region of the upper end edge (side edge part along the length direction) of the stress absorbing portion 18. In particular, the reinforcement plate F constituting the reinforcing portion 15 is connected to a part of the upper edge part of the flat plate portion 14 on the folded upper end edge part thereof. The tip-side reinforcement plate portion 22 is connected to the upper edge part of the mounting-side terminal portion 11 at the folded upper end edge part thereof.

By a structure for connecting the long reinforcement plate portion 19, the flat plate portion 14 and the mounting-side terminal portion 11 in a folded state, the flat plate portion 14 and the mounting-side terminal portion 11 are improved in rigidity and hardly deformed in response to an external force. The stress absorbing portion 18 and the coupling/reinforcing portion 23 arranged to overlap on the right side surface of the stress absorbing portion 18 are not directly connected and have no folded part. Thus, the stress absorbing portion 18 has a lower rigidity than the flat plate portion 14 and the mounting-side terminal portion 11. If such an external force as to relatively displace the mounting-side terminal portion 11 and the detached-side terminal portion 12 in the front-rear direction acts on the terminal fitting 10, the stress absorbing portion 18 is resiliently deformed, whereby the deformation of the mounting-side terminal portion 11 and that of the detached-side terminal portion 12 are prevented. That is, the stress absorbing portion 18 absorbs stress of the detached-side terminal portion 12 and the mounting-side terminal portion 11. As just described, the terminal fitting 10 can combine a high rigidity and stress relaxation in the detached-side terminal portion 12 and the mounting-side terminal portion 11.

Next, functions of this embodiment are described. In assembling the connector unit 70, the plurality of terminal fittings 10 are inserted into the terminal accommodation chambers 29 of the inner housing 25. Even if a load acts on the terminal fitting 10 during insertion, the terminal fitting 10 has a rigidity sufficient to withstand that load. The support plate 30 and the FPC 55 are bonded to configure the circuit board P in a step different from the insertion of the terminal fittings 10.

Subsequently, the inner engaging projections 26 of the inner housing 25 are fit into the third positioning holes 33 of the circuit board P. In this way, the tips of the mounting-side terminal portions 11 are inserted into the guide holes 31 without butting against the support plate 30. The step portions 16 formed on the tip-side reinforcement plate portion 22 come into contact with the opening edge parts 34 of the guide holes. Then, insertion depths of the detached-side terminal portions 12 into through holes (guide holes 31 and connection holes 57) of the circuit board P become constant and the postures of the terminal fittings 10 with respect to the circuit board P are stabilized. In this way, the connection stability of the terminal fitting 10 and the mating terminal T is stabilized for all the terminal fittings 10. Further, since each terminal fitting 10 is hardly inclined and the postures of all the terminal fittings 10 are stabilized, the breakage of the terminal fittings 10 and stress concentration due to posture inclination hardly occur.

Subsequently, the mounting-side terminal portions 11 and the FPC 55 are soldered on a surface of the FPC 55 opposite to the support plate 30 and the inner housing 25, and the terminal fittings 10 are mounted on the FPC 55. The terminal fitting 10 fixed by soldering elongates in the front-rear direction due to thermal expansion. If the terminal fitting 10 elongates, there is a concern that the front end of the detached-side terminal portion 12 is buckled by butting against a front wall portion of the terminal accommodation chamber 29. At this time, stress in the mounting-side terminal portion 11 and the detached-side terminal portion 12 is relaxed by the resilient deformation of the stress absorbing portion 18 and the coupling/reinforcing portion 23. Further, since the mounting-side terminal portion 11 and the detached-side terminal portion 12 are enhanced in rigidity by the tip-side reinforcement plate portion 22 and the reinforcing portion 15, excessive deformation and breakage hardly occur.

Subsequently, the outer engaging projections 42 of the outer housing 40 are passed through the first positioning holes 56 of the FPC 55 and the second positioning holes 32 of the support plate 30 and the outer housing 40 is fixed to the circuit board P by heat fusion. A load is applied to the mounted terminal fitting 10 due to the thermal shrinkage of a part fixed by heat fusion, but the terminal fitting 10 can relax stress in the mounting-side terminal portion 11 and the detached-side terminal portion 12 by the resilient deformation of the stress absorbing portion 18 and the coupling/reinforcing portion 23. Further, since the curved deformation of the flat plate portion 14 is made less likely to occur by the reinforcement plate portions A, B, stress in the flat plate portion 14 can be relaxed.

Subsequently, the holder 60 is fit to the outer housing 40. In this way, the circuit board P and the through portions 53 of the terminal fittings 10 are protected. Out of the FPC 55, a part to which the support plate 30 is not bonded is bent in the protection space 45, and is drawn out to outside behind the holder 60 through the clearance 51 between the coupling portion 65 and the lower wall portion 48.

The terminal fitting 10 of this embodiment is provided with the detached-side terminal portion 12 to be connected to the mating terminal T, the mounting-side terminal portion 11 to be mounted on the circuit board P and the stress absorbing portion 18 arranged between the detached-side terminal portion 12 and the mounting-side terminal portion 11. According to this terminal fitting, 10, stress generated in the detached-side terminal portion 12 and the mounting-side terminal portion 11, out of the terminal fitting 10, can be relaxed by the resilient deformation of the stress absorbing portion 18.

The stress absorbing portion 18 and the detached-side terminal portion 12 are connected at the obtuse angle β, and the stress absorbing portion 18 and the mounting-side terminal portion 11 are connected at the obtuse angle γ. According to this configuration, the material cost of the terminal fitting 10 can be reduced as compared to the case where parts of the stress absorbing portion 18 connected to the detached-side terminal portion 12 and the mounting-side terminal portion 11 are right-angled or acute-angled. Further, since stress hardly concentrates on the bent parts in the both front and rear end parts of the stress absorbing portion 18, breakage hardly occurs.

The detached-side terminal portion 12 includes the flat plate portion 14 directly connected to the stress absorbing portion 18 and the reinforcing portion 15 for reinforcing the flat plate portion 14. Since the rigidity of the flat plate portion 14 is enhanced by the reinforcing portion 15, stress generated in the flat plate portion 14 can be reduced.

The reinforcing portion includes the first reinforcement plate portion (reinforcement plate portions A, B) arranged side by side with the flat plate portion 14 in the plate thickness direction by being folded from the one side edge part (upper end edge part), out of the two side edge parts along the length direction of the flat plate portion 14. The reinforcement plate portions A, B are folded from the side edge part along the length direction of the flat plate portion 14 and arranged side by side with the flat plate portion 14 in the plate thickness direction, whereby the rigidity of the flat plate portion 14 is enhanced.

The reinforcing portion 15 includes the second reinforcement plate portion 20 extending in the plate thickness direction from the other side edge part (lower end edge part), out of the two side edge parts along the length direction of the flat plate portion 14. Since the second reinforcement plate portion 20 extends perpendicularly from the flat plate portion 14, the rigidity of the flat plate portion 14 is enhanced.

The terminal fitting 10 is provided with the long reinforcement plate portion 19 including the first reinforcement plate portion (reinforcement plate portions A, B) and arranged along the flat plate portion 14, the stress absorbing portion 18 and the mounting-side terminal portion 11. The side edge part (upper end edge part) along the length direction of the long reinforcement plate portion 19 is connected to the side edge part (upper end edge part) along the length direction of the flat plate portion 14 and the side edge part (upper end edge part) along the length direction of the mounting-side terminal portion 11. The upper end edge part of the long reinforcement plate portion 19 is separated from the side edge part (upper end edge part) along the length direction of the stress absorbing portion 18. According to this configuration, since the long reinforcement plate portion 19 is connected to the side edge parts along the length direction of the flat plate portion 14 and the mounting-side terminal portion 11, the rigidity of the entire terminal fitting 10 can be enhanced. Since the stress absorbing portion 18 is not directly connected to the long reinforcement plate portion 19, a stress relaxation function is not impaired.

Out of the long reinforcement plate portion 19, the tip-side reinforcement plate portion 22 arranged along the mounting-side terminal portion 11 is formed with the step portion 16 for contacting the opening edge part of the through hole (guide hole 31) in the circuit board P. According to this configuration, since the insertion depths of the mounting-side terminal portions 11 into the circuit board P become constant and stress is uniformly applied to each terminal fitting 10, the stress is hardly locally applied to each terminal fitting 10.

The detached-side terminal portion 12 includes the penetrating tube portion 13. The spring piece 24 for resiliently contacting the mating terminal T is provided in the tube portion 13. When the mounting-side terminal 12 and the mounting-side terminal portion 11 are viewed in a penetration direction of the tube portion 13, the mounting-side terminal portion 11 is arranged outside the tube portion 13. A gap inspection is conducted for the terminal fittings 10 before being mounted into the inner housing 25 by laser light. In the gap inspection, it is inspected whether or not a length of the clearance (gap) a between the inner surface of the right wall portion of the tube portion 13 and the spring piece 24 is within a proper range. In this inspection, detection light such as laser light is irradiated to the inside of the tube portion 13 from front or behind the tube portion 13. In this embodiment, the mounting-side terminal portion 11 is arranged outside (to the left of) the tube portion 13 when the detached-side terminal portion 12 and the mounting-side terminal portion 11 are viewed in the penetration direction of the tube portion 13 as shown in FIG. 7. That is, the mounting-side terminal portion 11 is not present within the range of the clearance a on an optical path of the detection light. Therefore, the gap inspection can be properly conducted.

### Other Embodiments

The present invention is not limited to the above described and illustrated embodiment, but is represented by claims. The present invention includes all changes in the scope of claims and in the meaning and scope of equivalents and also includes the following embodiments.

(1) Although the long reinforcement plate portion 19 includes the tip-side reinforcement plate portion 22, the coupling/reinforcing portion 23, the reinforcement plate F, the coupling plate 21 and the reinforcement plate E in this embodiment, the long reinforcement plate portion 19 may not be provided with the coupling plate 21.

(2) Although the mounting-side terminal portion 11 is arranged outside (to the left of) the tube portion 13 when the detached-side terminal portion 12 and the mounting-side terminal portion 11 are viewed in the penetration direction of the tube portion 13 in this embodiment, the mounting-side terminal portion 11 may be arranged inside the tube portion 13 if the gap inspection is not conducted.

(3) Although the second reinforcement plate portion 20 extending in the plate thickness direction from the lower end edge part of the flat plate portion 14 is provided in this embodiment, the second reinforcement plate portion 20 may not be provided.

(4) Although the tip-side reinforcement plate portion 22 is formed with the step portion 16 for contacting the opening edge part 34 of the guide hole 31 in the support plate 30 in this embodiment, the step portion 16 may not be formed.

(5) Although the reinforcing portion 15 includes the reinforcement plate portion A separated from the flat plate portion 14 in this embodiment, the reinforcing portion 15 may be entirely arranged along the flat plate portion 14 without forming a clearance therebetween.

(6) Although the tip-side reinforcement plate portion 22 is arranged side by side in close contact with the detached-side terminal portion 12 in the plate thickness direction in this embodiment, the tip-side reinforcement plate portion 22 may be arranged to form a certain clearance between the detached-side terminal portion 12 and the tip-side reinforcement plate portion 22.

(7) Although the front end part of the second reinforcement plate portion 20 is connected to the lower wall portion of the tube portion 13 in this embodiment, the front end part of the second reinforcement plate portion 20 may not necessarily be connected to the tube portion 13 if extending in the plate thickness direction from one of the two side edge parts of the flat plate portion 14.

(8) Although the flat plate portion 14 extends from the left surface of the tube portion 13 in this embodiment, the flat plate portion 14 may extend from another surface of the tube portion 13.

(9) Although the first reinforcement plate portion (reinforcement plate portions A, B) extends from the upper end edge part of the flat plate portion 14 and the second reinforcement plate portion 20 extends from the lower end edge part in this embodiment, the second reinforcement plate portion 20 may extend from the upper end edge part of the flat plate portion 14 and the first reinforcement plate portion (reinforcement plate portions A, B) may extend from the lower end edge part.

List of Reference Numerals

| | |
|---|---|
| 10 | terminal fitting |
| 11 | mounting-side terminal portion |
| 12 | detached-side terminal portion |
| 13 | tube portion |
| 14 | flat plate portion |
| 15 | reinforcing portion |
| 16 | step portion |
| 18 | stress absorbing portion |
| 19 | long reinforcement plate portion |
| 20 | second reinforcement plate portion |
| 21 | coupling plate |
| 22 | tip-side reinforcement plate portion |
| 23 | coupling/reinforcing portion |
| 24 | spring piece |
| 25 | inner housing |
| 26 | inner engaging projection |
| 27 | terminal through hole |
| 28 | terminal accommodation wall |
| 29 | terminal accommodation chamber |
| 30 | support plate |
| 31 | guide hole |
| 32 | second positioning hole |
| 33 | third positioning hole |
| 34 | opening edge part of guide hole |
| 40 | outer housing |
| 41 | inner engaging claw |
| 42 | outer engaging projection |
| 43 | terminal insertion opening |
| 44 | housing accommodation chamber |
| 45 | protection space |
| 47 | front wall portion |
| 48 | lower wall portion |
| 49 | upper wall portion |
| 50 | inner bottom |
| 51 | clearance |
| 53 | through portion |
| 55 | FPC |
| 56 | first positioning hole |
| 57 | connection hole |
| 60 | holder |
| 61 | base plate portion |
| 62 | outer engaging claw |
| 63 | suppressing plate |
| 64 | protruding portion |
| 65 | coupling portion |
| 70 | connector unit |
| A | reinforcement plate portion (first reinforcement plate portion) |
| B | reinforcement plate portion (first reinforcement plate portion) |
| C | contact point portion |
| D | reinforcement plate |
| E | reinforcement plate |
| F | reinforcement plate |
| P | circuit board |
| T | mating terminal |
| α | clearance |
| β | obtuse angle |
| γ | obtuse angle |

1. A terminal fitting, comprising:
a detached-side terminal portion to be connected to a mating terminal;
a mounting-side terminal portion to be mounted on a circuit board; and
a stress absorbing portion arranged between the detached-side terminal portion and the mounting-side terminal portion.

2. The terminal fitting of claim 1, wherein:
the stress absorbing portion and the detached-side terminal portion are connected at an obtuse angle, and
the stress absorbing portion and the mounting-side terminal portion are connected at an obtuse angle.

3. The terminal fitting of claim 1, wherein the detached-side terminal portion includes:
a flat plate portion directly connected to the stress absorbing portion; and
a reinforcing portion for reinforcing the flat plate portion.

4. The terminal fitting of claim 3, wherein the reinforcing portion includes a first reinforcement plate portion folded from one side edge part, out of two side edge parts along a length direction of the flat plate portion, and arranged side by side with the flat plate portion in a plate thickness direction.

5. The terminal fitting of claim 4, wherein the reinforcing portion includes a second reinforcement plate portion extending in the plate thickness direction from the other side edge part, out of the two side edge parts along the length direction of the flat plate portion.

6. The terminal fitting of claim 4, comprising a long reinforcement plate portion including the first reinforcement plate portion and arranged along the flat plate portion, the stress absorbing portion and the mounting-side terminal portion, wherein:
a side edge part along the length direction of the long reinforcement plate portion is connected to a side edge part along the length direction of the flat plate portion and a side edge part along the length direction of the mounting-side terminal portion and separated from a side edge part along the length direction of the stress absorbing portion.

7. The terminal fitting of claim 6, wherein a tip-side reinforcement plate portion arranged along the mounting-side terminal portion, out of the long reinforcement plate portion, is formed with a step portion for contacting an opening edge part of a through hole in the circuit board.

8. The terminal fitting of claim 1, wherein:
the detached-side terminal portion includes a penetrating tube portion,
a spring piece for resiliently contacting the mating terminal is provided in the tube portion, and
the mounting-side terminal portion is arranged outside the tube portion when the detached-side terminal portion and the mounting-side terminal portion are viewed in a penetration direction of the tube portion.
